(19) United States
(12) Patent Application Publication
(10) Pub. No.: US 2020/0337400 A1
(43) Pub. Date: Oct. 29, 2020

(54) FLORAL ARRANGEMENT INSERT

(71) Applicant: Patricia SCHMIDT, Dallas, TX (US)

(72) Inventor: Patricia SCHMIDT, Dallas, TX (US)

(21) Appl. No.: 16/395,816

(22) Filed: Apr. 26, 2019

(51) Int. Cl. A41G 1/02; B44C 5/06; B29C 44/18; B29C 43/02

(52) U.S. Cl. CPC A41G 1/02; B44C 5/06; B29K 2105/04; B29C 43/021; B29C 44/18

(57) ABSTRACT

A floral arrangement insert comprising: a foam insert; a plurality of tubes arranged and removably secured in the foam insert in a pre-designed configuration; and a plurality of artificial foliage inserted into the foam insert and around the plurality of tubes in a pre-designed configuration. A method of manufacturing a floral arrangement insert comprising: obtaining or preparing a mold; filling the mold with an expandable, curable foam to form a foam insert; inserting a plurality of tubes into the foam in a pre-designed configuration; causing or allowing the foam to cure after insertion of the plurality of tubes; and removing the foam insert from the mold after the foam has cured. The plurality of tubes can be filled with water and an artificial or fresh flower and/or foliage can be inserted into the plurality of tubes to create a beautiful floral piece.

### TECHNICAL FIELD

A floral arrangement insert can be used to construct pre-arranged floral pieces. The pre-arranged floral pieces allow a user to create the pieces that look professional, realistic, and with ease.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a top perspective view of a floral arrangement insert according to certain embodiments.

FIG. 2 is a top perspective view of the insert of FIG. 1 showing additional components according to certain embodiments.

FIG. 3 is a cross-sectional view of the insert showing other additional components.

FIG. 4 is a cross-sectional view of an insert according to certain other embodiments.

### DETAILED DESCRIPTION

It is desirable to have beautifully arranged floral pieces in one's home. For example, it is common to want floral pieces, especially centerpieces, during holidays while hosting family and friends, during other occasions when visitors are at one's home, and for weddings. It is also common for businesses to display floral pieces in various locations throughout the business facility. Additionally, it is oftentimes desirable to cut flowers from one's yard and display the flowers as a floral piece.

However, there are a limited number of options for arranged floral pieces: arrange the flowers and foliage yourself; purchase a pre-arranged floral piece from a florist or grocery store for example; or hire a company to arrange the flowers and foliage. Purchasing pre-arranged floral pieces from a florist or store and hiring a company can both be extremely expensive. Moreover, most people lack the knowledge and/or skill to arrange flowers and foliage themselves in order to make the floral piece appear professionally arranged. Thus, there is a need for a floral arrangement system that allows one to create floral pieces themselves where the floral arrangement appears professionally arranged.

It has been discovered that a floral arrangement insert can include a plurality of tubes located within a foam insert. The tubes are pre-arranged in a desired configuration whereby the user can simply insert one or more flowers and/or foliage into the tubes to create a beautifully, professionally appearing floral arrangement. The foam insert can also include a plurality of artificial foliage pre-arranged within the foam insert surrounding the tubes. Some of the advantages to the floral arrangement insert is water located within each of the plurality of tubes does not become contaminated by contact with the stems of other flowers or foliage due to separation of the flowers in individual tubes. Thus, this unique feature can extend the life and appearance of the flowers. According to certain embodiments, other unique advantages to the foam insert of the floral arrangement system is the foam is non-toxic and retains its shape.

According to certain embodiments, a floral arrangement insert comprises: a foam insert; a plurality of tubes arranged and removably secured in the foam insert in a pre-designed configuration; and a plurality of artificial foliage inserted into the foam insert and around the plurality of tubes in a pre-designed configuration.

A method of manufacturing a floral arrangement insert comprises: obtaining or preparing a mold; filling the mold with an expandable, curable foam to form a foam insert; inserting a plurality of tubes into the foam in a pre-designed configuration; causing or allowing the foam to cure after insertion of the plurality of tubes; and removing the foam insert from the mold after the foam has cured.

It is to be understood that the discussion of preferred embodiments regarding the floral arrangement insert is intended to apply to the device embodiments and the method embodiments.

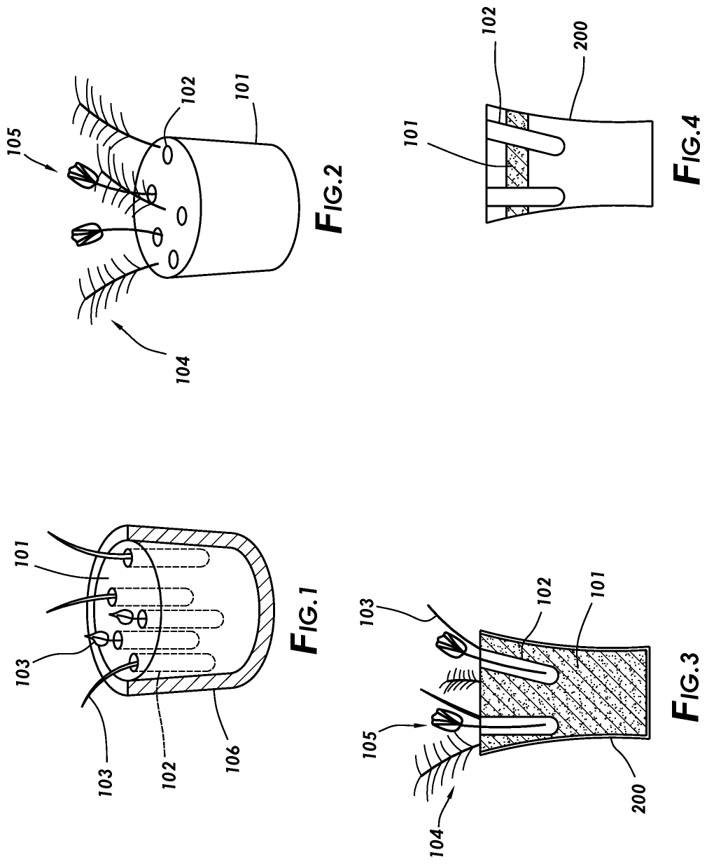

Turning to the figures, FIG. 1 is a perspective view of a floral arrangement insert according to certain embodiments. The floral arrangement insert includes a foam insert 101. The foam insert 101 can be made from an expandable, curable foam. As used herein, the term “expandable” means the foam in a liquid state increases at least 30% in volume by expansion. As used herein, the term “curable” means the ability to set and harden over a period of time. A “liquid” means the ability to flow and conform to the outline of a container. Accordingly, the foam can be inserted into a mold, expand to fill the mold, and then harden into a foam insert. The foam is commonly called a spray foam and is generally made up of two different chemical compounds that mix together to create the foam. Common examples of chemical compounds include, but are not limited to, isocyanates and a resin (e.g., polyol resin). It is to be understood that any chemical compounds can be used to create the foam insert provided that foam insert obtains the following properties: expandable; curable; water resistant; a sufficient hardness after curing such that mechanical action is necessary to create openings within the foam. As used herein, the term “water resistant” means the cured foam does not imbibe water and become water-logged. The foam insert can also be made with foam, commonly called “green foam” or any other type of foam, for example STYROFON®, which is a type of extruded polystyrene foam. However, green foam can be toxic, brittle, floats in water, hard to work with, and does not retain the initial shape. Therefore, according to certain embodiments, the foam insert is not made from green foam.

The foam insert 101 can be a variety of dimensions. According to certain embodiments, the foam insert 101 has a height and diameter such that the foam insert can be placed within a vase. Accordingly, the height and diameter of the vase can be measured and the foam insert has dimensions slightly less than the height and diameter of the vase. Vases commonly measure between heights of 3 inches (in.) to 36 in. and diameters of 3 in. to 36 in. According to certain embodiments, the foam insert 101 has a height between 1 in to 36 in. and a diameter between 3 to 36 in. For square or rectangular floral pieces, the length and width of the foam insert 101 can range from 2 in. to 60 in.

The floral arrangement insert also includes a plurality of tubes 102. The plurality of tubes 102 are arranged and removably secured in the foam insert 101 in a pre-designed configuration. The number of tubes can vary based on the diameter of the foam insert 101. By way of example, a diameter of 3 in. may require only 3 tubes 102; whereas a diameter of 24 in. may require 12 or more tubes. Floral arranging is a field that requires knowledge and skill to create a beautiful floral piece. As such, one of skill in the art will be able to select the exact number of tubes and the pre-designed configuration based on the knowledge and skill as well as the diameter of the foam insert 101.

The plurality of tubes 102 can be made from a variety of different materials including, but not limited to glass, metals, metal alloys, and hardened plastic such as polycarbonates. The plurality of tubes 102 can have a variety of different dimensions. By way of example, each of the plurality of tubes 102 can have a diameter of about 1 in. and a height of 6 in. Each of the plurality of tubes 102 contains a flat or rounded closed bottom, generally straight sides, and an open top. Accordingly, the plurality of tubes 102 can contain a substance such as water or sand without the substance leaking from the tubes.

The bottoms of the plurality of tubes 102 can be located above, near, below, or at the bottom of the foam insert 101.

As shown in FIGS. 1 and 3, the floral arrangement insert can further include a plurality of tube indicators 103. Each of the plurality of tube indicators 103 can correspond to the plurality of tubes 102 such that each tube has at least one tube indicator. In this manner, the user can more easily locate each of the plurality of tubes 102 for removal from the foam insert 101, filling with water or another substance, and placement of artificial or fresh flowers into the tubes. The plurality of tube indicators 103 can be selected from artificial foliage, dried grasses, dried willows (e.g., pussy willows), and combinations thereof. The plurality of tube indicators 103 can be permanently or removably attached to an upper portion of the tubes, for example, via floral tape or glue. The plurality of tube indicators 103 can alternatively be removably inserted into the foam insert 101 near the location of each tube. This embodiment can be useful for aiding the user to find the location where each tube should be re-inserted into the foam insert. According to another embodiment, the plurality of tube indicators are attached to each of the tubes and also inserted into the foam insert near each tube.

As can be seen in FIGS. 2 and 3, the floral arrangement insert also includes a plurality of artificial foliage 104 inserted into the foam insert 101 and around the plurality of tubes 102 in a pre-designed configuration. One of ordinary skill in the art of floral design will be able to select the type, quantity, and placement of the plurality of artificial foliage 104. It is to be understood that the term “foliage” includes leaves, vines, grasses, and willows. The floral arrangement insert can also include dried grasses and dried willows in addition to the artificial foliage. According to certain embodiments, the plurality of artificial foliage 104 is different from the plurality of tube indicators 103. In this manner, the user can more easily identify the location of the plurality of tubes 102. Additionally, the selection of and placement of the plurality of artificial foliage 104 covers the entirety of the foam insert 101 and tops of the plurality of tubes 102. By covering the foam insert and tops of the tubes, a passerby will be unlikely to see the foam insert and tubes, which makes a more attractive floral piece. According to another embodiment, the top of the foam insert 101 can be covered with a natural or artificial moss or other covering similar to mosses.

As can be seen in FIGS. 2 and 3, artificial and/or fresh flowers can be inserted into the plurality of tubes 102. Because the plurality of tubes 102 are arranged in the foam insert 101 in a pre-designed configuration, after placement of the artificial and/or fresh flowers into each of the plurality of tubes 102, a beautiful floral piece is achieved. The stems of the artificial and/or fresh flowers can be cut such that the flower is a desired distance above the top of the plurality of tubes 102. By way of example, the stems can be cut to give a length of 8 in. to 12 in. with the distance from the top of the tube being 2 in. to 6 in. The floral arrangement insert can be sold with artificial flowers selected by the customer inserted into the plurality of tubes 102.

FIG. 4 shows a foam insert 101 according to certain other embodiments. As shown in FIG. 4, the bottoms of the plurality of tubes 102 are located below the bottom of the foam insert 101. This embodiment can be useful for a customer who wishes to special order a floral arrangement insert for a vase the customer has. In this manner, the customer can provide the diameter and height of the vase and the dimensions of the foam insert 101 and the plurality of tubes 102 can be selected such that the floral arrangement insert can be placed within the customer's vase. According to these embodiments, the height of the foam insert 101 can range from 1 in. to 6 in.

The floral arrangement insert is inserted into a vase for displaying the floral piece. The vase can have a variety of dimensions and be made from a variety of materials, such as glass, crystal, metals, metal alloys, and ceramics. As discussed above regarding concealing the foam insert 101, if the vase is transparent, then the sides of the foam insert 101 can be covered with a natural or artificial moss or similar covering. In the event the vase is opaque, such a covering around the sides of the foam insert is not necessary as a person will be unable to see the sides of the foam insert through the vase.

In practice, a user can insert an artificial flower into the each of the plurality of tubes 102. The user can also insert more than one flower into each of the plurality of tubes 102; however, because the number and configuration of the tubes was pre-designed by one of ordinary skill in the art, only one flower per tube may be preferable. A user can also place succulents into the plurality of tubes 102. If the user desires to use fresh flowers, then the user simply locates each of the plurality of tubes 102, for example, by identifying the plurality of tube indicators 103, filling each of the tubes with water, and inserting at least one flower per tube. It may ease the user in filling the tubes with water by removing each tube from the foam insert 101, filling with water, and then reinserting the tube into the foam insert. However, the user may also fill each tube with water by simply pouring water directly into each tube. The user can also refill the tubes with water as the water level becomes diminished or depleted.

A method of manufacturing the floral arrangement insert includes: obtaining or preparing a mold; inserting a plurality of tubes into the foam in a pre-designed configuration; and removing the foam insert from the mold after the foam has cured.

For use of an expandable, curable foam, the methods can further include filling the mold with an expandable, curable foam to form a foam insert; and causing or allowing the foam to cure after insertion of the plurality of tubes. The step of causing the foam to cure can include application of heat to the foam.

The method can further include selecting the dimensions of the mold such that the foam insert can be placed within a vase having specific dimensions.

In order for the plurality of tubes 102 to be removably secured within an expandable, curable foam insert, the plurality of tubes 102 can be inserted into the foam after the foam has at least partially cured. This step can help ensure the plurality of tubes remain in the pre-designed configuration. The method can further include gently twisting the plurality of tubes after insertion and before the foam has fully cured. In this manner, the foam does not bond to the outside of the tubes during the curing process so the tubes can be removed for filling with water if desired. If the foam insert is made from green foam or other types of non-expandable foams, the step of inserting the plurality of tubes can include using mechanical action and a tool, such as a rod or other cutting implement, to bore a plurality of holes to house the tubes.

The method can also include inserting the plurality of artificial foliage into the foam insert and surrounding the plurality of tubes after removing the foam from the mold. The foam insert can then be placed into a vase after removing the foam insert from the mold and/or after inserting the plurality of artificial foliage. Because the foam expands during curing, it may be necessary to mechanically reduce the dimensions of the foam insert to be capable of fitting within the vase. By way of example, the diameter of the foam insert can be reduced by trimming the circumference with a knife or other tool.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While devices, systems, and methods are described in terms of “comprising,” “containing,” or “including” various components or steps, the compositions, systems, and methods also can “consist essentially of” or “consist of” the various components and steps.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a−b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A floral arrangement insert comprising:
a foam insert;
a plurality of tubes arranged and removably secured in the foam insert in a pre-designed configuration; and
a plurality of artificial foliage inserted into the foam insert and around the plurality of tubes in a pre-designed configuration.

2. The floral arrangement insert according to claim 1, wherein the foam insert is made from an expandable, curable foam.

3. The floral arrangement insert according to claim 1, wherein the foam insert is made from a non-expandable foam, and wherein the non-expandable foam is green foam or an extruded polystyrene foam.

4. The floral arrangement insert according to claim 1, wherein the foam insert has a circular outer diameter and has a height between 1 inch to 36 inches and a diameter between 3 to 36 inches, or wherein the foam insert has a square or rectangular outer perimeter and has a length and width between 2 to 60 inches.

5. The floral arrangement insert according to claim 1, wherein the plurality of tubes are made from glass, metals, metal alloys, or hardened plastic.

6. The floral arrangement insert according to claim 1, wherein a closed end of the plurality of tubes are located above, near, below, or at the bottom of the foam insert.

7. The floral arrangement insert according to claim 1, further comprising a plurality of tube indicators, wherein each of the plurality of tube indicators corresponds to the plurality of tubes such that each tube has at least one tube indicator.

8. The floral arrangement insert according to claim 7, wherein the plurality of artificial foliage is different from the plurality of tube indicators.

9. The floral arrangement insert according to claim 8, wherein the plurality of tube indicators is selected from the group consisting of artificial foliage, dried grasses, dried willows, and combinations thereof.

10. The floral arrangement insert according to claim 8, wherein the plurality of tube indicators are permanently or removably attached to an upper portion of the plurality of tubes.

11. The floral arrangement insert according to claim 8, wherein the plurality of tube indicators are removably inserted into the foam insert near the location of each of the plurality of tubes.

12. A method of manufacturing a floral arrangement insert comprising:
obtaining or preparing a mold;
filling the mold with an expandable, curable foam to form a foam insert;
inserting a plurality of tubes into the foam in a pre-designed configuration;
causing or allowing the foam to cure after insertion of the plurality of tubes; and
removing the foam insert from the mold after the foam has cured.

13. The method according to claim 12, wherein the step of inserting occurs after the foam has at least partially cured.

14. The method according to claim 12, further comprising gently twisting the plurality of tubes after insertion and before the foam has fully cured.

15. The method according to claim 12, further comprising inserting a plurality of artificial foliage into the foam insert and surrounding the plurality of tubes after removing the foam from the mold.

16. The method according to claim 15, further comprising placing the foam insert into a vase after removing the foam insert from the mold.

17. A method of manufacturing a floral arrangement insert comprising:
obtaining a non-expandable foam;
creating a plurality of holes within the foam in a pre-designed configuration;
inserting a plurality of tubes into the plurality of holes; and
trimming the foam to obtain desired outer dimensions to create a foam insert.

18. The method according to claim 17, wherein the foam is selected from green foam or an extruded polystyrene foam.

19. The method according to claim 17, wherein each of the plurality of holes spans the entire height of the foam insert.

20. The method according to claim 17, further comprising placing the foam insert into a vase after removing the foam insert from the mold.
